(19) United States
(12) Patent Application Publication
(10) Pub. No.: US 2020/0278197 A1
(43) Pub. Date: Sep. 3, 2020

(54) MEASUREMENT APPARATUS, MEASUREMENT METHOD, SYSTEM, STORAGE MEDIUM, AND INFORMATION PROCESSING APPARATUS

(71) Applicant: CANON KABUSHIKI KAISHA, Tokyo (JP)

(72) Inventor: Takumi Tokimitsu, Utsunomiya-shi (JP)

(21) Appl. No.: 16/796,098

(22) Filed: Feb. 20, 2020

(30) Foreign Application Priority Data
Feb. 28, 2019 (JP) 2019-036399

(51) Int. Cl. G01B 11/25; G06K 9/20; G01B 11/00; G06K 9/03

(52) U.S. Cl. CPC G01B 11/2513; G06K 9/2036; G06K 2009/2045; G06K 9/03; G01B 11/002

(57) ABSTRACT

The present invention provides a measurement apparatus including a processing unit configured to perform a process of obtaining three-dimensional information regarding an object based on a first image obtained by a first image capturing unit and a second image obtained by a second image capturing unit, wherein the processing unit corrects, based on a model representing a measurement error and using first three-dimensional measurement values obtained from data of the first image and data of the second image corresponding to an overlap region captured by both of the first image capturing unit and the second image capturing unit, a measurement error of a second three-dimensional measurement value obtained from data of one of the first image and the second image corresponding to a non-overlap region captured by the one of the first image capturing unit and the second image capturing unit.

### BACKGROUND OF THE INVENTION

### Field of the Invention

The present invention relates to a measurement apparatus, a measurement method, a system, a storage medium, and an information processing apparatus.

### Description of the Related Art

A three-dimensional measurement technique using images obtained by capturing a measurement object can be used for various purposes such as generation of a three-dimensional model from the measurement object (actual object) and measurement of the position and posture of the measurement object. In a stereo method, which is one of the representative methods of the three-dimensional measurement technique, three-dimensional measurement is performed, based on the principle of triangulation, using images obtained by two image capturing units (stereo image capturing units) whose relative positions and postures are known.

In such three-dimensional measurement, in order to improve reliability, it is widely performed that one of the stereo image capturing units is replaced with an illumination unit such as a projector and a pattern (pattern light) for three-dimensional measurement is projected onto the measurement object. Further, each of Japanese Patent Laid-Open Nos. 2015-21862 and 2018-146348 proposes a technique that enables measurement of a measurement object including a glossy surface having a strong specular component by using images obtained by a plurality of image capturing units arranged in different directions with respect to a projector. Such a technique also has an effect of reducing the blind region of the entire system by capturing a region, that is a blind region for one image capturing unit of the plurality of image capturing units, by the other image capturing unit. Furthermore, it also has an effect of improving sensor noise and noise in the vicinity of the contour by combining measurement results obtained by the plurality of image capturing units. As a method of combining the measurement results of the respective image capturing units, averaging measurement coordinate values and the like have been disclosed.

However, in the three-dimensional measurement technique, since the image capturing unit or the projector (optical system thereof) may expand or contract depending on the temperature and its relative position and posture may change, there may be a deviation in measurement result of a measurement point on the measurement object due to a temperature change. In particular, in the optical system of the projector, the object temperature and the temperature distribution with surroundings are likely to change due to the heat generated by a light source. In addition, when a reflective display element is used, since the optical system includes a reflective surface, it is often sensitive to deformation due to temperature or the like. Accordingly, it is required to correct the temperature change, but, in an environment in which the temporal temperature change is large, it is difficult to perform high-accuracy temperature correction, and generation of a correction residual error becomes a problem. However, such a correction residual error can be greatly reduced by combining the measurement results obtained by the plurality of image capturing units.

As described above, the technique disclosed in each of Japanese Patent Laid-Open Nos. 2015-21862 and 2018-146348 enables three-dimensional measurement by using the measurement result of only one image capturing unit even when there is a blind region or the measurement object has glossiness (a dynamic range of large light quantity). However, in the region for which the measurement result of only one image capturing unit is used, the averaging effect of reducing the correction residual error or the like as described above cannot be obtained.

Note that a method is conceivable in which a large number of image capturing units are arranged so as not to substantially generate a blind region and a region in which the light quantity falls outside the dynamic range, but this leads to an increase in apparatus cost and processing speed. Also, a method is conceivable in which correction markers are arranged in the measurement region space and correction is performed using the measurement results of these markers. However, this requires the correction markers to be arranged, so that the usability is impaired.

### SUMMARY OF THE INVENTION

The present invention provides a measurement apparatus advantageous in measuring the position of a measurement object with high accuracy.

According to one aspect of the present invention, there is provided a measurement apparatus that performs three-dimensional measurement of an object, including a projection unit configured to project pattern light onto the object, a first image capturing unit and a second image capturing unit each configured to obtain an image of the object with the pattern light projected thereon by capturing the object from a direction different for each image capturing unit, and a processing unit configured to perform a process of obtaining three-dimensional information regarding the object based on a first image obtained by the first image capturing unit and a second image obtained by the second image capturing unit, wherein the processing unit corrects, based on a model representing a measurement error and using first three-dimensional measurement values obtained from data of the first image and data of the second image corresponding to an overlap region captured by both of the first image capturing unit and the second image capturing unit, a measurement error of a second three-dimensional measurement value obtained from data of one of the first image and the second image corresponding to a non-overlap region captured by the one of the first image capturing unit and the second image capturing unit.

Further aspects of the present invention will become apparent from the following description of exemplary embodiments with reference to the attached drawings.

### BRIEF DESCRIPTION OF THE DRAWINGS

FIG. 1 is a schematic view showing the basic arrangement of a measurement apparatus as one aspect of the present invention.

FIG. 2 is a flowchart for explaining a distance measurement method.

FIGS. 3A and 3B are views each showing an example of a pattern projected from a projection unit onto a measurement object.

FIG. 4 is a view showing an example of a gray code and a spatial code.

FIG. 5 is a flowchart showing the details of a distance combining step shown in FIG. 2.

FIG. 6 is a view for explaining measurement error reduction performed by combining measurement distances.

FIGS. 7A to 7D are views for explaining a measurement error caused by the rotation or magnification change of the projection unit.

FIGS. 8A to 8C are views for explaining periodic error correction.

FIG. 9 is a view showing the arrangement of a system including the measurement apparatus shown in FIG. 1 and a robot.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate.

Furthermore, in the attached drawings, the same reference numerals are given to the same or similar configurations, and redundant description thereof is omitted.

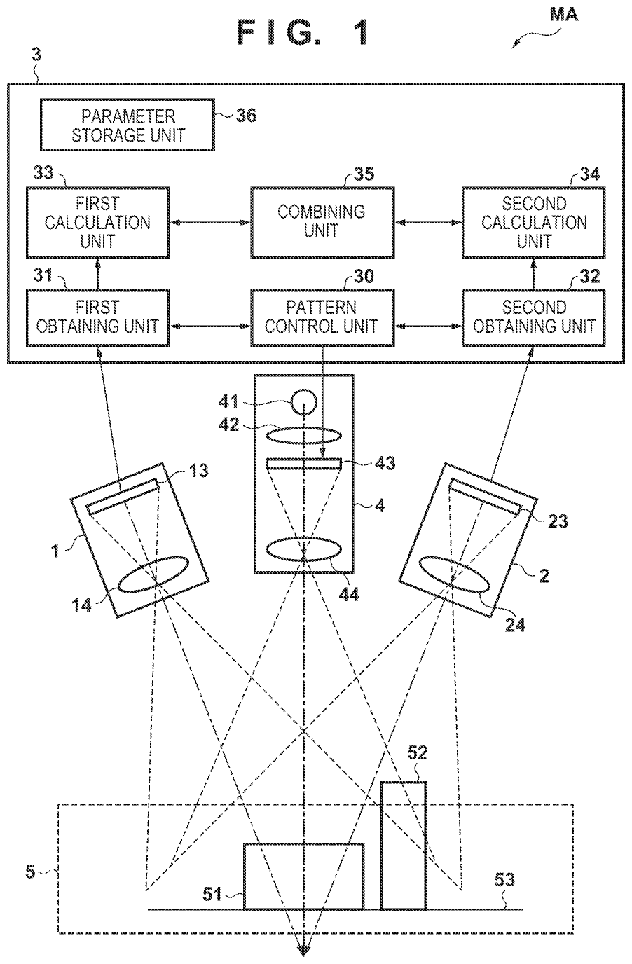

FIG. 1 is a schematic view showing the basic arrangement of a measurement apparatus MA as one aspect of the present invention. The measurement apparatus MA is an apparatus that measures the position (shape (three-dimensional distance)) of each of measurement objects 51 and 52 serving as a measurement target scene 5 and, for example, embodied as a distance measurement apparatus. The measurement apparatus MA includes a projection unit 4 that projects pattern light onto the measurement object, and a first image capturing unit 1 and a second image capturing unit 2 each of which obtains an image by capturing, from a direction different for each image capturing unit, the measurement object with the pattern light projected thereon. Further, the measurement apparatus MA includes a processing unit 3 that performs a process of obtaining information regarding the position (shape) of each of the measurement objects 51 and 52 based on at least one of a first image obtained by the first image capturing unit 1 and a second image obtained by the second image capturing unit 2.

The projection unit 4 includes a light source 41, an illumination optical system 42, a display element 43, and a projection optical system 44. As the light source 41, a halogen lamp or various types of light emitting elements such as an LED can be used. The illumination optical system 42 is an optical system for guiding light emitted from the light source 41 to the display element 43. Note that light entering the display element 43 preferably has a uniform incident angle distribution. Therefore, for example, an optical system such as a Koehler illumination system or a diffuser suitable for uniformizing the brightness distribution is used as the illumination optical system 42. A transmission type LED, a reflection type LCOS, or a DMD can be used as the display element 43. The display element 43 spatially controls the transmittance or the reflectance upon guiding the light from the illumination optical system 42 to the projection optical system 44. The projection optical system 44 is an optical system for forming an image of the pattern displayed on the display element 43 at a specific position (measurement point) of each of the measurement objects 51 and 52.

The first image capturing unit 1 includes a first image capturing lens 14 and a first image capturing element 13. Similarly, the second image capturing unit 2 includes a second image capturing lens 24 and a second image capturing element 23. The first image capturing lens 14 is an optical system for forming an image of the specific position of the measurement object on the first image capturing element 13. Similarly, the second image capturing lens 24 is an optical system for forming an image of the specific position of the measurement object on the second image capturing element 23. Various types of photoelectric conversion elements such as a CMOS sensor and a CCD sensor can be used as the first image capturing element 13 and the second image capturing element 23. The first image capturing unit 1 and the second image capturing unit 2 are arranged so as to sandwich the projection unit 4, and more specifically, are arranged symmetrically with respect to the projection unit 4.

The processing unit 3 controls the projection unit 4, the first image capturing unit 1, and the second image capturing unit 2 to perform a process of obtaining the shape, that is, the three-dimensional distance of each of the measurement objects 51 and 52 by processing images obtained by the first image capturing unit 1 and the second image capturing unit 2. The processing unit 3 includes, as hardware, a general-purpose computer (information processing apparatus) including a CPU, a memory, a display, a storage device such as a hard disk, and various types of input/output interfaces. The processing unit 3 includes, as software, a program that causes the computer to execute the measurement method (distance measurement method) according to this embodiment. By executing the program on the CPU, the processing unit 3 implements the respective units including a pattern control unit 30, a first obtaining unit 31, a second obtaining unit 32, a first calculation unit 33, a second calculation unit 34, a combining unit 35, and a parameter storage unit 36.

The pattern control unit 30 generates pattern data corresponding to a pattern to be projected onto the measurement objects 51 and 52 and stores the pattern data in the storage device in advance. Further, the pattern control unit 30 reads out the pattern data stored in the storage device as required, and transmits the pattern data to the projection unit 4 via, for example, a general-purpose display interface such as a DVI. Furthermore, the pattern control unit 30 controls the operation of the projection unit 4 via a general-purpose communication interface such as an RS232C or IEEE488 interface. Note that the projection unit 4 displays the pattern to be projected onto the measurement objects 51 and 52 on the display element 43 based on the pattern data.

The first obtaining unit 31 captures a digital image signal sampled and quantized by the first image capturing unit 1, obtains image data represented by image brightness values (density values) of respective pixels from the image signal, and stores the image data in the memory. Similarly, the second obtaining unit 32 captures a digital image signal sampled and quantized by the second image capturing unit 2, obtains image data represented by image brightness values of respective pixels from the image signal, and stores the image data in the memory. Note that the first obtaining unit 31 and the second obtaining unit 32 control the operations (image capturing timings) of the first image capturing unit 1 and the second image capturing unit 2, respectively, via a general-purpose communication interface such as an RS232C or IEEE488 interface.

The first obtaining unit 31, the second obtaining unit 32, and the pattern control unit 30 operate in cooperation with each other. When the display element 43 displays a pattern to be projected onto the measurement objects 51 and 52, the pattern control unit 30 transmits a signal to each of the first obtaining unit 31 and the second obtaining unit 32. Upon receiving the signal from the pattern control unit 30, the first obtaining unit 31 and the second obtaining unit 32 operate the first image capturing unit 13 and the second image capturing unit 23, respectively, to capture the measurement objects 51 and 52 by the first image capturing unit 1 and the second image capturing unit 2. When the capturing of the measurement objects 51 and 52 is completed, each of the first obtaining unit 31 and the second obtaining unit 32 transmits a signal to the pattern control unit 30. Upon receiving the signal from each of the first obtaining unit 31 and the second obtaining unit 32, the pattern control unit 30 changes the pattern displayed on the display element 43 to the next pattern. By sequentially repeating this operation, pattern images are obtained for all patterns to be projected onto the measurement objects 51 and 52.

The first calculation unit 33 calculates the distance of each of the measurement objects 51 and 52 based on the pattern images (first images) obtained by the first obtaining unit 31. Similarly, the second calculation unit 34 calculates the distance of each of the measurement objects 51 and 52 based on the pattern images (second images) obtained by the second obtaining unit 32. In this embodiment, distance measurement is performed using a phase shift method that detects a pattern phase using a phase shift pattern. Regarding the ambiguity of the phase detected by the phase shift method, a known technique using a space encoding method that obtains an unwrapped phase by assigning the detected phase to a spatial code obtained by a gray code pattern is utilized. However, the measurement method to which the present invention is applicable is not limited to the phase shift method and the space encoding method.

The combining unit 35 combines the calculation results (measurement distances) calculated by the first calculation unit 33 and the second calculation unit 34. The combining unit 35 will be described in detail later.

The parameter storage unit 36 stores parameters necessary for obtaining the three-dimensional distance of each of the measurement objects 51 and 52. The parameters stored in the parameter storage unit 36 include, for example, device parameters related to the projection unit 4, the first image capturing unit 1, and the second image capturing unit 2, internal parameters related to the projection unit 4, the first image capturing unit 1, and the second image capturing unit 2, and the like. The parameters stored in the parameter storage unit 36 also include a periodic error correction parameter, external parameters between the projection unit 4 and the first image capturing unit 1, external parameters between the projection unit 4 and the second image capturing unit 2, and the like.

The device parameters include the number of pixels of the display element 43, the number of pixels of the first image capturing element 13, the number of pixels of the second image capturing element 23, and the like. The internal parameters include a focal length, an image center, a coefficient of image distortion due to distortion, and the like, which are obtained by a calibration of the internal parameters. The periodic error correction parameter includes a parameter for correcting a periodic error during phase detection caused by a deviation, from a sine wave, of the waveform of the pattern (pattern light) projected onto the measurement objects 51 and 52. This parameter is obtained by a calibration before measurement. The external parameters between the projection unit 4 and the first image capturing unit 1 include a translation vector and a rotation matrix that represent a relative positional relationship between the projection unit 4 and the first image capturing unit 1. Similarly, the external parameters between the projection unit 4 and the second image capturing unit 2 include a translation vector and a rotation matrix that represent a relative positional relationship between the projection unit 4 and the second image capturing unit 2. They are obtained by a calibration of the external parameters.

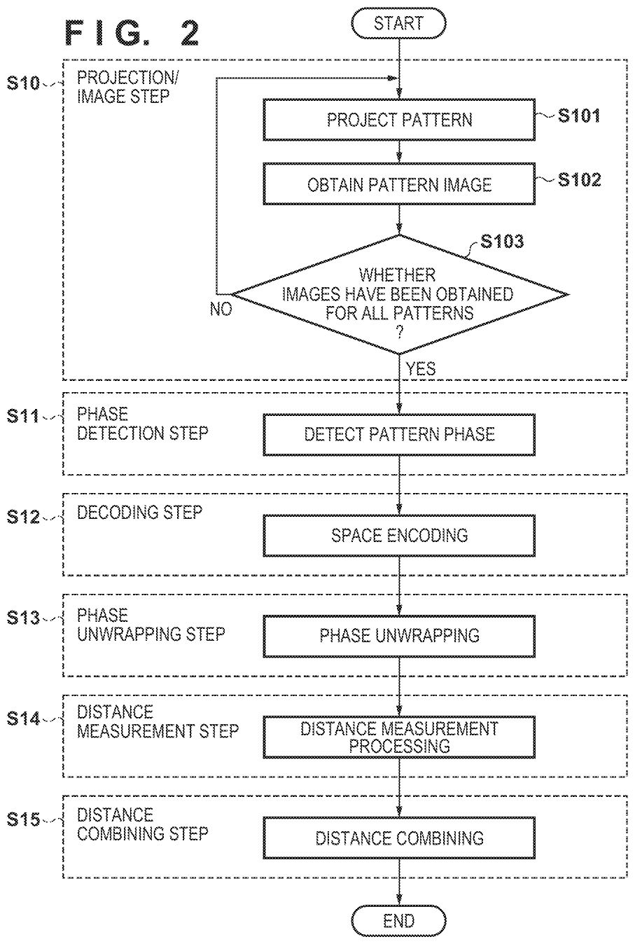

With reference to FIG. 2, the principle of distance measurement using the space encoding method and the phase shift method and a method of combining the measurement distance obtained by the first image capturing unit 1 and the measurement distance obtained by the second image capturing unit 2 will be described. FIG. 2 is a flowchart for explaining the distance measurement method (a calculation method for calculating the position of a measurement object) according to this embodiment. Distance measurement performed by each of the first image capturing unit 1 and the second image capturing unit 2 is roughly divided into five steps: projection/image capturing step S10, phase detection step S11, decoding step S12, phase unwrapping step S13, and distance measurement step S14. Steps S10 to S14 are executed for each of the first image capturing unit 1 and the second image capturing unit 2 and, in distance combining step S15, a final measurement distance is obtained by combining the measurement distance obtained by the first image capturing unit 1 and the measurement distance obtained by the second image capturing unit 2.

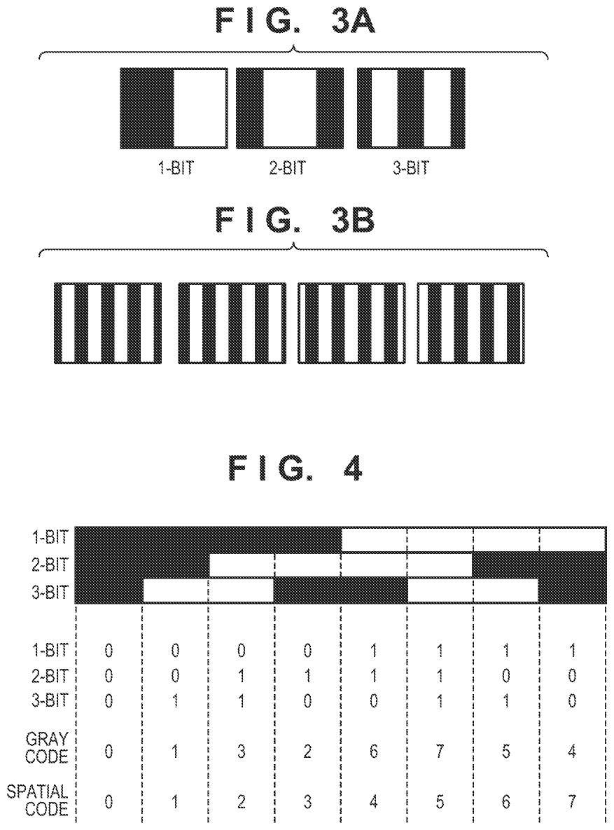

Projection/image capturing step S10 includes steps S101, S102, and S103. In step S101, a pattern is projected from the projection unit 4 onto the measurement objects 51 and 52. More specifically, a gray code pattern shown in FIG. 3A and a phase shift pattern shown in FIG. 3B are sequentially projected onto the measurement objects 51 and 52. FIGS. 3A and 3B are views showing an example of the patterns projected from the projection unit 4 onto the measurement objects 51 and 52. Since the gray code pattern shown in FIG. 3A is a 3-bit gray code pattern of the space encoding method, light emitted from the projection unit 4 can be divided into 2³ (=8) portions. When the number of bits is increased, the number of patterns projected onto the measurement objects 51 and 52 is increased, and the number of divided portions of the light emitted from the projection unit 4 can be increased. For example, in the case of 10 bits, the light emitted from the projection unit 4 can be divided into 2¹⁰ (=1024) portions. Further, in this embodiment, as shown in FIG. 3B, a four-step method of projecting four patterns obtained by sequentially shifting the bright/dark period by ¼ is used for the phase shift pattern. In general, the shorter phase shift pattern period can result in the higher measurement accuracy. Therefore, for example, when a display element of a type that divides pixels, for example, a DMD is used as the display element 43, it is preferable to repeat ON and OFF every two pixels to set the pattern period to be short within a range in which the phase shift is possible.

In step S102, each of the first image capturing unit 1 and the second image capturing unit 2 captures the measurement objects 51 and 52 with the pattern projected thereon, and obtains a pattern image. Note that from the viewpoint of measurement time, it is preferable to simultaneously operate the first image capturing unit 1 and the second image capturing unit 2 in accordance with the timing of projecting the pattern onto the measurement objects 51 and 52 and obtain a pattern image by each of the first image capturing unit 1 and the second image capturing unit 2.

In step S103, it is determined whether images have been obtained for all the patterns to be projected onto the measurement objects 51 and 52. If images have been obtained for all the patterns, the process advances to phase detection step S11. On the other hand, if images have not been obtained for all the patterns, the process returns to step S101, and the next pattern is projected onto the measurement objects 51 and 52.

In phase detection step S11, the pattern phase of each pixel is obtained for the phase shift pattern images among the pattern images. In the phase shift method, a pattern phase φ of each pixel is obtained using following equation (1) based on the four patterns shown in FIG. 3B obtained by sequentially shifting the pattern phase by ¼ period.

φ=tan⁻¹{(I0−I2)/(I1−I3)}×P (1)

In equation (1), each of I0 to I3 is the brightness value of an arbitrary pixel in each phase shift pattern. P is a coefficient for scaling the phase of ±π [rad] calculated by tan⁻¹ so as to match the coordinates of the display element 43. In this embodiment, one period is formed by the four pixels of the display element 43 so that the coefficient P is 4/2π [pixel/rad].

Note that in the projection unit 4, it is preferable that the projection optical system 44 is defocused within a range in which the resolution of the pattern is not greatly deteriorated so as to form the pattern projected onto the measurement objects 51 and 52 to be a sine wave. It is also possible to obtain a sine wave by defocusing the first image capturing unit 1 and the second image capturing unit 2 or by applying a smoothing filter to an image obtained by each of the first image capturing unit 1 and the second image capturing unit 2. However, from the viewpoint of resolution, it is preferable that the pattern projected onto the measurement objects 51 and 52 is formed to be a sine wave.

Note that if the pattern projected onto the measurement objects 51 and 52 deviates from a sine wave, an error corresponding to the phase to be measured, that is, a so-called periodic error is generated, so that the measurement accuracy is lowered. Since the periodic error depends on the waveform of the pattern projected onto the measurement objects 51 and 52, it can be corrected by obtaining the periodic error characteristic by a prior apparatus calibration and storing it in the apparatus. However, in general, the waveform of the pattern projected onto the measurement objects 51 and 52 depends on the field angle and the defocus amount of the projection unit 4, that is, the three-dimensional approximate position of each of the measurement objects 51 and 52 onto which the pattern is to be projected. Therefore, it is preferable to correct the periodic error using the periodic error characteristic corresponding to the three-dimensional approximate position of each of the measurement objects 51 and 52. The three-dimensional approximate position of each of the measurement objects 51 and 52 may be given in advance. Alternatively, the temporary measurement coordinates may be obtained, in the procedure similar to steps S12 to S14 to be described below, using the phase without a periodic error correction, and recalculated using the phase with the periodic error corrected. In addition, since a periodic error changes depending on the defocus amount, it varies depending on the temperature, but also greatly depends on the defocus amount of the projection optical system 44. Accordingly, similar variations of the periodic error due to a temperature change occur in the first image capturing unit 1 and the second image capturing unit 2. Therefore, the periodic error can be canceled and reduced by combining the measurement distances.

In decoding step S12, space encoding is performed. More specifically, for each pixel of the gray code pattern image of each bit, binary determination based on bright/dark is performed. An average image of four phase shift pattern images may be used as the threshold for the binary determination. By arranging the results of the binary determination in order, a 3-bit gray code is generated as shown in FIG. 4. By converting the 3-bit gray code into a 3-bit spatial code, the direction (emission direction) of light emitted from the projection unit 4 can be grasped. FIG. 4 is a view showing an example of the gray code and the spatial code.

In phase unwrapping step S13, phase unwrapping is performed. More specifically, for each pixel of the pattern image, phase detected in step S11 is assigned to the spatial code obtained in step S12, thereby converting a discrete spatial code into a spatial code having substantially continuous values. With this operation, it becomes possible to grasp the emission direction of light from the projection unit 4 with higher resolution.

In distance measurement step S14, distance measurement processing is performed based on the principle of triangulation based on the emission direction of light from the projection unit 4 and the incident directions of light incident on the first image capturing unit 1 and the second image capturing unit 2. In order to obtain the incident direction of the light entering the first image capturing unit 1 from the pixel information of the pattern image, the internal parameters related to the first image capturing unit 1 are used and the distortion of the first image capturing unit 1 is corrected. Assume that the coordinates of an arbitrary pixel of the pattern image obtained by the first image capturing unit 1 are (UC1i, VC1i), and the coordinates of the pixel after distortion correction are (UC1i′, VC1i′). The subscript i is a pixel number on the image obtained by the first image capturing unit 1. Although the pixels are two-dimensionally arranged, for the sake of descriptive convenience, a one-dimensional ID is assigned herein to the pixel as the ith pixel. The spatial code detected by the pixel coordinates (UCi, VCi) indicates the pixel position on the display element 43 before the distortion correction. With using this pixel position as UPi, the pixel position (UCi′, VCi′) on the display element 43 after the distortion correction is obtained, and the emission direction of the pattern is obtained. Since an epipolar constraint is used for the distortion correction of the projection unit 4, in addition to the internal parameters related to the projection unit 4, the external parameters between the projection unit 4 and the first image capturing unit 1 are used. The external parameters between the projection unit 4 and the first image capturing unit 1 are also used when performing the distance measurement processing based on the principle of triangulation. Note that in order to use each of the measured measurement points in distance combining step S15, it is stored as three-dimensional coordinates (data) obtained by associating the measurement point ID i, the three-dimensional coordinates, the pixel position (UC1i, VC1i), and the position (UPi′,VPi′) on the display element. Similarly, for the second image capturing unit 2, assuming that the pixel number in the pattern image obtained by the second image capturing unit 2 is j, and three-dimensional coordinates of the measurement point are obtained by associating the pixel position (UC2j,VC2j) in the pattern image and the position (UPj′, VPj′) on the display element.

In this manner, each of the first image capturing unit 1 and the second image capturing unit 2 can obtain the measurement distance through steps S10 to S14. Then, distance combining step S15 for combining the measurement distances obtained by the first image capturing unit 1 and the second image capturing unit 2 to obtain a more accurate measurement distance will be described.

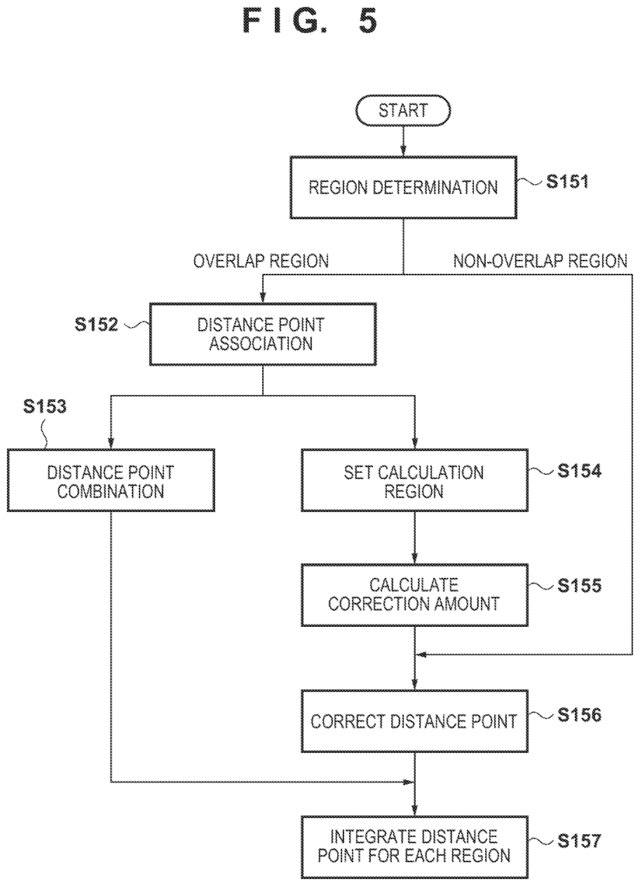

FIG. 5 is a detailed flowchart of distance combining step S15. Distance combining step S15 includes steps S151 to S157.

In step S151, region determination is performed. In this embodiment, with respect to the measurement region of the measurement objects 51 and 52, an overlap region in which both of the first image capturing unit 1 and the second image capturing unit 2 can perform distance point measurement (image capturing) and a non-overlap region in which only one of the first image capturing unit 1 and the second image capturing unit 2 can perform distance point measurement are defined. Note that a region in which neither the first image capturing unit 1 nor the second image capturing unit 2 can perform distance point measurement is defined as a defective region. Such region definition is performed on the coordinates (UP′, UV′) of the display element 43. More specifically, the region definition is performed by dividing the coordinates of the display element 43 into a grid pattern, and determining whether each region divided by the grid includes one or more coordinates (UPi′, VPi′) of the measurement points on the display element obtained by the first image capturing unit 1 and one or more coordinates (UPj′, VPj′) of the measurement points on the display element obtained by the second image capturing unit 2. In addition, the region to which each measurement point belongs is determined and associated with the measurement point ID.

In step S152 distance point association is performed. More specifically, with respect to the measurement points of the respective image capturing units in the region determined (defined) as the overlap region in step S151, the points obtained by measuring the identical positions of the measurement objects 51 and 52 are identified and associated with each other. For an arbitrary measurement point of the first image capturing unit 1, the measurement point (UPj′, VPj′) of the second image capturing unit 2 present closest to the coordinates (UPi′, VPi′) on the display element 43 is searched for, and a correspondence list between the pixel number i of the first image capturing unit 1 and the pixel number j of the second image capturing unit 2 is generated. Note that in the association, if the measurement point (UPj′, VPj′) of the second image capturing unit 2 do not exist within a certain range, it is preferable to exclude the arbitrary measurement point as an inappropriate measurement point.

In step S153, distance point combination is performed. More specifically, the three-dimensional coordinates of the measurement points obtained by the image capturing units and associated with each other in step S152 are combined. For such combination, simple averaging may be used, or averaging considering weighting based on the phase shift signal intensity or the like may be used. By such combination, an effect of reducing (canceling) the measurement error generated in each of the first image capturing unit 1 and the second image capturing unit 2 can be obtained. Not only the averaging effect of random coordinate errors caused by sensor noise is obtained, but also an effect of canceling the errors caused by a parameter change in the optical system due to a temperature change is obtained. In particular, in the projection unit 4, the object temperature and the temperature distribution with the surroundings are likely to change due to the heat generated by the light source 41. In addition, when a reflective display element is used, since the optical system includes a reflective surface, it is sensitive to a change due to temperature or the like, resulting in a decrease in thermal stability.

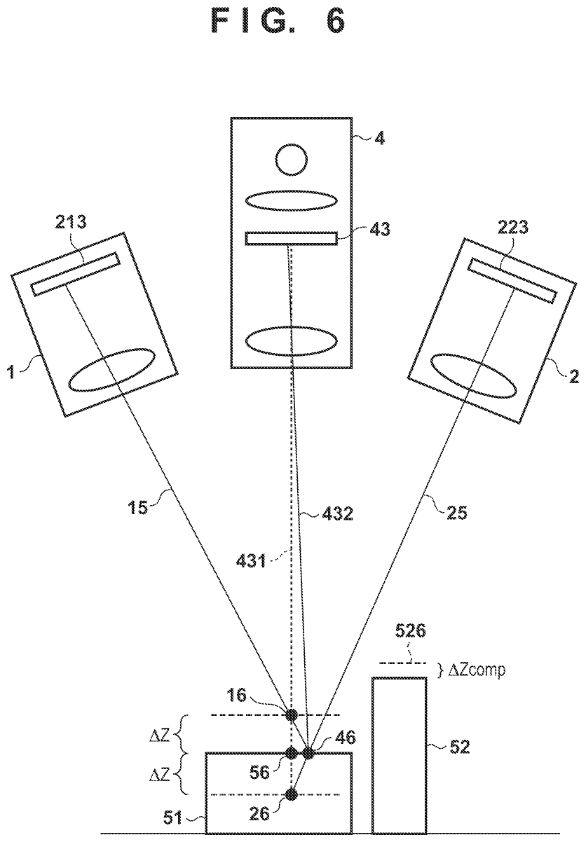

With reference to FIG. 6, generation of a measurement error due to a change in the state of the projection unit 4 and measurement error reduction by combining the measurement distance obtained by the first image capturing unit 1 and the measurement distance obtained by the second image capturing unit 2 will be described. Here, a translation change of the display element 43 will be described as an example, but the same applies to other errors related to the projection unit 4 such as a change in periodic error due to a defocus change.

The emission direction of light passing through a coordinate UPx of an arbitrary pixel of the display element 43 is indicated by a straight line 431, and a case will be described in which the display element 43 causes a slight translational shift in a direction orthogonal to the optical axis of the projection unit 4 due to an environmental change such as a temperature change. As the display element 43 shifts, the actual emission direction of the light passing through the coordinate UPx changes from the straight line 431 to a straight line 432. The pattern corresponding to the coordinate UPx is projected on an intersection 46 between the straight line 432 and the surface of the measurement object 51, and captured by the first image capturing unit 1 in the incident light path indicated by a straight line 15 and by the second image capturing unit 2 in the incident light path indicated by a straight line 25. Since the internal parameters related to the projection unit 4 and stored in the parameter storage unit 36 are parameters for the unshifted display element 43, the first image capturing unit 1 obtains a distance point 16 and the second image capturing unit 2 obtains a distance point 26 in this case. Since the distance point 16 and the distance point 26 have the same coordinate UPx on the display element 43, they are determined to be distance points belonging to the overlap region in step S151 and combined in step S153. Thus, a distance point 56 can be obtained. As shown in FIG. 6, the distance point 56 is a distance point in which the error of the distance point 16 and that of the distance point 26 in the optical axis direction of the projection unit 4 are canceled and corrected (the accuracy has been improved). Strictly speaking, an error also occurs in a direction orthogonal to the optical axis of the projection unit 4. However, when the distance to the measurement region of the measurement object 51 is long and the convergence angle is small, this error can be ignored for the error in the distance direction.

In the overlap region, the effect of improving the measurement accuracy by error cancellation can be obtained as described above. However, in the non-overlap region, only one of the measurement point obtained by the first image capturing unit 1 and the measurement point obtained by the second image capturing unit 2 exists, so the effect of improving the measurement accuracy cannot be obtained. Therefore, in this embodiment, in steps S154, S155, and S156, a change in parameter is obtained from the difference between the distance points in the overlap region to use it in correction, thereby improving the measurement accuracy even for the distance point in the non-overlap region. The distance point obtained in step S1.53 and the distance point obtained in step S156 are integrated in step S157 and output as a final distance point.

In step S154, a calculation region for calculating a correction amount for correcting the measurement error is set in the overlap region. In order to calculate the correction amount with higher accuracy, a region obtained by excluding the edge region of each of the measurement objects 51 and 52 where the brightness changes sharply and the region where the surface inclination amount of the measurement object is larger than a reference inclination amount (the region where the surface inclination is large) may be set as the calculation region. The edge region of each of the measurement objects 51 and 52 can be detected from the amplitude change of the phase shift signal in the corresponding image. The region where the surface inclination amount of each of the measurement objects 51 and 52 is larger than the reference inclination amount can be detected by providing a threshold for a change in the detected phase (a change in the spatial code) in the corresponding image.

In step S155, a correction amount for correcting the measurement error is calculated. More specifically, among the distance points in the calculation region set in step S154, a change in parameter of the projection unit 4 is calculated from the distance point obtained by the first image capturing unit 1 and the distance point obtained by the second image capturing unit 2 that are associated with each other. Here, it is assumed that only the distance point 16 and the distance point 26 are included in the calculation region. In this case, when the coordinate deviation of the distance point 16 from the distance point 56 is AZ and the shift amount (correction amount) of the display element 43 to be corrected is ΔUP, ΔUP can be obtained by following equation (2). Therefore, equation (2) is a model representing a measurement error corresponding to the state of the projection unit 4, and a model representing a measurement error due to a variation of the distance between each of the first image capturing unit 1 and the second image capturing unit 2 and the measurement object 51 (measurement region) caused by the optical axis deviation of the projection unit 4.

ΔUP=ΔZ·f·L/WD² (2)

In equation (2), f is the focal length of the projection unit 4, L is a baseline length which is the distance between each of the first image capturing unit 1 and the second image capturing unit 2 and the projection unit 4, and WD is a distance between the projection unit 4 and the measurement object 51. Since the distance WD is sufficiently larger than the measurement error, that is, the difference between the distance point 16 and the distance point 26, the distance WD may be the distance to the distance point 16 or the distance to the distance point 26. Here, for each of the first image capturing unit 1 and the second image capturing unit 2, the shift amount ΔUP is obtained using a pair of the distance points 16 and 26, but the shift amount ΔUP may be obtained using a plurality of pairs of the distance points included in the calculation region. Further, not only when the display element 43 has a translation error but also when the display element 43 is rotated about the optical axis or the magnification of the projection unit 4 has changed, the shift amount ΔUP has a distribution of the coordinates (UP, VP) on the display element 43. However, it is possible to predict the distribution of the shift amount ΔUP based on the coordinate deviations AZ of the plurality of pairs of the distance points.

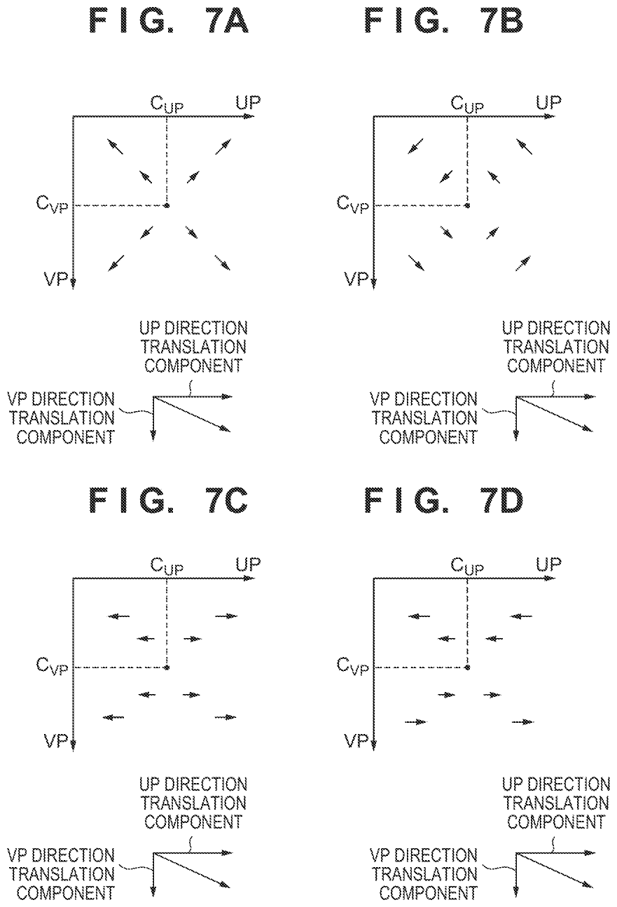

With reference to FIGS. 7A to 7D, a measurement error caused by the rotation or magnification change of the projection unit 4 will be described. A vector representing the change direction at each location on the coordinates of the display element 43 indicates a magnification component in a pattern change in FIG. 7A, and indicates a rotation component in FIG. 7B. In FIGS. 7A and 7B, the length of the vector indicates the change amount on the coordinates of the display element 43, and the direction of the vector indicates the change direction. Note that in FIGS. 7A and 7B, the vector is illustrated longer than the actual change amount on the coordinates of the display element 43. C_{UP} and C_{VP} indicate the coordinate center of the display element 43. The magnification component is parameterized such that the change amount increases in proportion to the distance from the coordinate center of the display element 43. The change direction is set to a radial direction. The radiation direction is a direction parallel to a vector connecting the coordinate center of the display element 43 and respective coordinates on the display element 43. The rotation component is parameterized such that the change amount increases in proportion to the distance from the coordinate center of the display element 43. The change direction of the rotation component is a tangential direction unlike the magnification component. The tangential direction is a direction perpendicular to a vector connecting the coordinate center of the display element 43 and respective coordinates on the display element 43.

FIG. 7C shows the vectors in the UP-axis direction extracted from the pattern change vectors of the magnification components shown FIG. 7A, and FIG. 7D shows the vectors in the UP-axis direction extracted from the pattern change vectors of the rotation components shown in FIG. 7B. A measurement error occurs is the UP-axis direction substantially orthogonal to the epipolar Each of FIGS. 7C and 7D shows the measurement error at each position on the coordinates of the display element 43. In addition, it can be seen that the magnification component shown in FIG. 7C has a change amount proportional to UP and the rotation component shown in FIG. 7D has a change amount proportional to VP.

In equation (2), the change of the display element 43 is described assuming that an error caused only by the translation component is considered as a target and there is no distribution of the change vector in each location on the coordinates of the display element 43. However, in a case in which there is a distribution of the change vector in each location on the coordinates of the display element 43, a correction amount for correcting the measurement error can be obtained using following equations (3) and (4). Therefore, regarding the magnification component, a correction amount may be calculated in accordance with a model representing a measurement error due to a variation of the relative position of each of the first image capturing unit 1 and the second image capturing unit 2 with respect to the measurement object 51 caused by a magnification change of the projection unit 4. Regarding the rotational component, a correction amount may be calculated in accordance with a model representing a measurement error due to a variation of the relative position of each of the first image capturing unit 1 and the second image capturing unit 2 with respect to the measurement object 51 caused by the rotation of the projection unit 4.

ΔUP(UP,VP)=AZ(UP,VP)=ΔZ(UP,VP)·f·L/WD(UP,VP)² (3)

ΔUP(UP,VP)=ΔUP_{shift}+ΔUP_{mag}(UP−Cᵤₚ)+ΔUPᵣₒₜ(VP−C_{VP}) (4)

Assume that ΔUP, ΔZ, and WD for each of a plurality of pairs of the distance points having different coordinates on the display element 43 are ΔUP (UP, VP), ΔZ (UP, VP), and WD (UP, VP). ΔUP_{shift} is a translation component, ΔUP_{mag} is a magnification component proportional to UP as described above, and ΔUPᵣₒₜ is a rotation component proportional to VP as described above. By obtaining the three parameters ΔUP_{shift}, ΔUP_{mag}, and ΔUPᵣₒₜ are obtained using equations (3) and (4) based on ΔZ (UP, VP) for a plurality of pairs of the distance points included in the calculation region, the measurement point in the non-overlap region can be corrected.

In step S156, the distance point is corrected. More specifically, the correction amount calculated in S155 is applied to the measurement coordinates associated with the measurement point in the non-overlap region defined in step S151. The correction amount ΔZ for each point can be obtained from ΔUP using the relationship similar to that in equation (1). For example, consider a case in which the upper surface of the measurement object 52 shown in FIG. 6 is glossy so the second image capturing unit 2 cannot capture the measurement object 52 due to a specular component. In this case, a correction amount ΔZcomp shown in FIG. 6 is applied to a measurement point group 526 including an error obtained by the first image capturing unit 1. With this operation, the measurement distance can be corrected to a correct distance. As shown in FIG. 6, the upper surface of the measurement object 52 is closer to the projection unit 4, the first image capturing unit 1, and the second image capturing unit 2 than the upper surface of the measurement object 51, so that the distance WD for the measurement object 52 is different from that for the measurement object 51. Even in such a case, this embodiment can obtain the correction amount ΔZ. Accordingly, it is possible to correct the measurement distance more accurately than a technique that performs six-axis adjustment on the distance point group of the first image capturing unit 1 and the distance point group of the second image capturing unit 2 in a three-dimensional space to match them.

The case in which the display element 43 is shifted from the optical axis (optical axis shift) has been described above, but the error component of the projection unit 4 is not limited to this. The similar correction can be performed in a case in which the display element 43 is rotated about the optical axis, a case in which the magnification of the projection unit 4 has changed, and a case in which the relative position of the projection unit 4 with respect to each of the first image capturing unit 1 and the second image capturing unit 2 has changed. A plurality of error factors can be simultaneously corrected. However, in that case, the degree of freedom in parameter correction is increased, so that the calculation region needs to be sufficiently diverse in space. For example, consider a case in which the display element 43 is not only shifted from the optical axis but also rotated about the optical axis. In this case, since the rotation component causes an error that the surface of the measurement object is inclined with respect to the apparatus, two parameters cannot be corrected simultaneously without a plurality of calculation regions or a sufficiently large calculation region. Accordingly, the degree of freedom of parameter correction may be determined in advance according to the error factor, or the degree of freedom may be increased or decreased according to the spatial distribution of the calculation region. The latter is more advantageous in securing a necessary and sufficient degree of freedom of correction as long as the overlap region is not very unevenly distributed with respect to the spatial extent of the measurement target scene 5. In addition, when there are two or more parameters that are substantially equal in sensitivity to an error, it is preferable to group them together. For example, the principal point position which is one of the internal parameters related to the first image capturing unit 1 and the second image capturing unit 2 and the relative angle in the baseline direction between the projection unit 4 and each of the first image capturing unit 1 and the second image capturing unit 2 have similar sensitivity to an error, so that one of them may be used as their representative.

In this embodiment, the example has been described in which the correction amount for the parameter related to projection unit 4 of each of the first image capturing unit 1 and the second image capturing unit 2 is calculated in the overlap region and the three-dimensional coordinates in the non-overlap region are obtained based on the correction amount. However, the present invention is not limited to this. For example, the three-dimensional coordinates in a region including the overlap region may be obtained based on the correction amount of the parameter related to the projection unit 4 of each of the first image capturing unit 1 and the second image capturing unit 2. Further, the three-dimensional coordinates may be directly corrected by each of the first image capturing unit 1 and the second image capturing unit 2 using the two measurement results in the overlap region without obtaining the correction amount of the parameter itself. As long as the measurement value in the non-overlap region to be obtained by each of the first image capturing unit 1 and the second image capturing unit 2 is calculated based on a plurality of measurement results in the overlap region, the present invention is not limited to the specific embodiment.

In this embodiment, the magnification component and the rotation component are expressed as error components proportional to the coordinates of the display element 43, and the correction amount is obtained using equation (4). However, instead of equation (4), the correction amount may be obtained using a distance sensitivity table generated by obtaining a change of a distance point with respect to a change in UP at the position of each distance point.

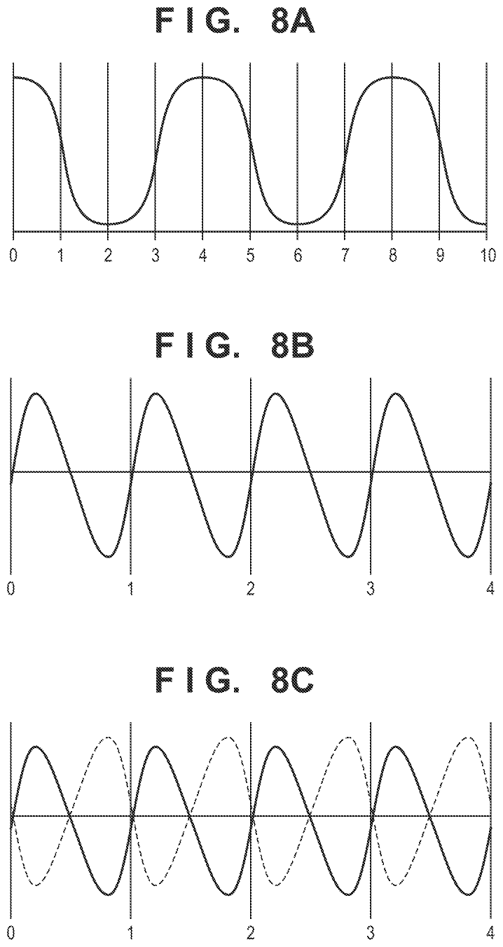

With reference to FIGS. 8A to 8C, periodic error correction will be described. As described above, periodic error correction is also included in distance combining step S15. A periodic error can also be canceled by averaging distance points in an overlap region in which both of the first image capturing unit 1 and the second image capturing unit 2 can capture an object, but the error remains in a non-overlap region. Therefore, for the error remaining in the non-overlap region, a correction amount is calculated in step S155 based on the respective measurement points obtained by the first image capturing unit 1 and the second image capturing unit 2 in a calculation region set in step S154, and the distance point is corrected.

FIG. 8A is a view showing the profile of one of the phase shift patterns. In FIG. 8A, the abscissa represents the coordinates [pix] of the display element 43, and the repetition pattern of the period formed by the four pixels of the display element 43 is used as described above. Further, the pseudo rectangular pattern of the display element 43 is formed close to a sine wave by defocusing the display element 43. However, in general, it is impossible to form the pattern to be a perfect sine wave. Therefore, as shown in FIG. 8B, a periodic error occurs in the detected phase at the time of phase detection. In FIG. 8B, the abscissa represents the fraction obtained by dividing the coordinates on the display element 43 by one period (4 pixels), and the ordinate represents the phase error. Since the pattern projected from the projection unit 4 has a rectangular wave whose harmonic has been attenuated by the optical system, when a phase shift is detected, a phase error having the ¼ period of the pattern period mainly occurs. A phase error ΔUPcyc due to the periodic error can be expressed by equation (5) using periodic error correction parameters R and I. In equation (5), UP is the coordinates on the display element 43 immediately after the phase detection and before the periodic error correction.

ΔUPcyc=R·cos(2πUP)+I·sin(2πUP) (5)

The periodic error can be corrected in accordance with the measured fractional phase if the parameters R and I in equation (5) are obtained in advance. In addition, it is preferable to obtain the parameters R and I as functions depending on the three-dimensional coordinates of the measurement point. In this case, correction can be performed even if the periodic error characteristic has a spatial distribution. However, the periodic error characteristic greatly depends on the defocus amount of the projection unit 4 due to a temperature change or a change in temperature distribution, and it is not realistic to obtain all the parameter changes in advance. Therefore, it is preferable to obtain a parameter change based on measurement values obtained by the first image capturing unit 1 and the second image capturing unit 2.

FIG. 8C shows the distance error that occurs when the phase error shown in FIG. 8B has occurred. In FIG. 8C, the ordinate represents the distance error, the solid line indicates the measurement value obtained by the first image capturing unit 1, and the broken line indicates the measurement value obtained by the second image capturing unit 2. When the phase errors are equal, the errors at the distance points obtained by the first image capturing unit 1 and the second image capturing unit 2 arranged symmetrically with respect to the projection unit 4 have different signs as in the case in which a translational deviation occurs in the display element 43. Accordingly, the errors can be canceled by averaging them. Therefore, the correction amount can be obtained from the deviation of the distance point obtained by the first image capturing unit 1 and the deviation of the distance point obtained by the second image capturing unit 2, the distance points being associated with each other.

In addition, since the periodic error component is a high-frequency component having a period of ¼ of the phase shift pattern, it can be easily separated from a low-frequency error due to a translational deviation of the display element 43 or the like. Therefore, the periodic error can be extracted by extracting one-pixel periodic component according to equation (5) for each of the distance point obtained by the first image capturing unit 1 and the distance point obtained by the second image capturing unit 2 in the calculation region. Using the extracted periodic error, the periodic error in the non-overlap region can be corrected.

According to this embodiment, the measurement value obtained in the non-overlap region can be corrected based on the measurement values obtained in the overlap region. Therefore, the shape of the measurement object can be measured with high accuracy without increasing the apparatus cost and the processing speed and impairing the usability.

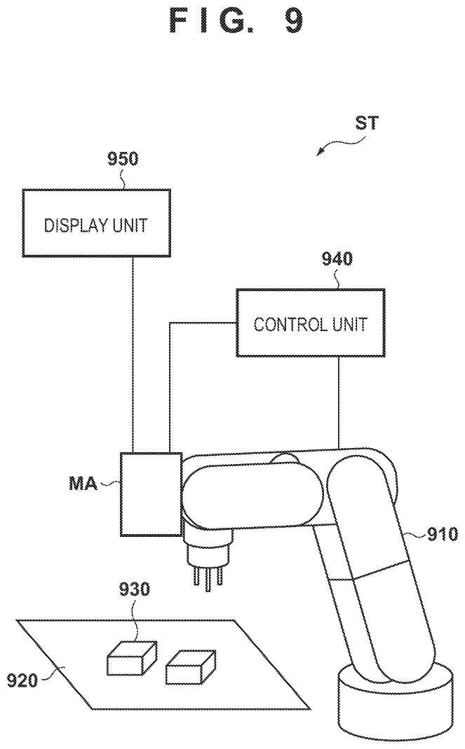

The measurement apparatus MA is used in a state in which it is supported by a support member, for example. In this embodiment, as an example, a system ST in which the measurement apparatus MA is attached to a robot arm (gripping apparatus) 910 as shown in FIG. 9 will be described. The measurement apparatus MA obtains information regarding the shape (position and posture) of an object (workpiece) 930 arranged on a support base 920 and inputs the information to a control unit 940. The control unit 940 controls the robot arm 910 by giving a drive instruction to the robot arm 910 based on the information regarding the position and posture of the object 930. The robot arm 910 holds and moves (for example, translates or rotates) the object 930 by a robot hand (gripping unit) attached to the tip. Further, by mounting (assembling) the object 930 to another part by the robot arm 910 (robot hand), an article composed of a plurality of parts, for example, an electronic circuit board or a machine can be manufactured. Furthermore, an article can be manufactured by processing the object 930 moved by the robot arm 910. The control unit 940 includes a computing device such as a CPU and a storage device such as a memory. Note that in this embodiment, the measurement apparatus MA obtains information regarding the shape of the object 930. However, the control unit 940 may obtain pattern images from the measurement apparatus MA and obtain information regarding the shape of the object 930. Further, the system ST may display measurement data or obtained images of the object 930 measured by the measurement apparatus MA on a display unit 950 such as a display.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-036399 filed on Feb. 28, 2019, which is hereby incorporated by reference herein in its entirety.

What is claimed is:

1. A measurement apparatus that performs three-dimensional measurement of an object, comprising:
a projection unit configured to project pattern light onto the object;
a first image capturing unit and a second image capturing unit each configured to obtain an image of the object with the pattern light projected thereon by capturing the object from a direction different for each image capturing unit; and
a processing unit configured to perform a process of obtaining three-dimensional information regarding the object based on a first image obtained by the first image capturing unit and a second image obtained by the second image capturing unit,
wherein the processing unit corrects, based on a model representing a measurement error and using first three-dimensional measurement values obtained from data of the first image and data of the second image corresponding to an overlap region captured by both of the first image capturing unit and the second image capturing unit, a measurement error of a second three-dimensional measurement value obtained from data of one of the first image and the second image corresponding to a non-overlap region captured by the one of the first image capturing unit and the second image capturing unit.

2. The apparatus according to claim 1, wherein the processing unit corrects the measurement error by determining, based on a model representing a measurement error corresponding to a state of the projection unit, a correction amount for correcting the measurement error, and applying the correction amount to the second three-dimensional measurement value.

3. The apparatus according to claim 1, wherein the model includes a model representing a measurement error due to a variation of a distance between each of the first image capturing unit and the second image capturing unit and a measurement region caused by an optical axis deviation of the projection unit.

4. The apparatus according to claim 1, wherein the model includes a model representing a measurement error due to a variation of a relative position of each of the first image capturing unit and the second image capturing unit with respect to a measurement region caused by a magnification change of the projection unit.

5. The apparatus according to claim 1, wherein the model includes a model representing a measurement error due to a variation of a relative position of each of the first image capturing unit and the second image capturing unit with respect to a measurement region caused by a rotation of the projection unit.

6. The apparatus according to claim 1, wherein the first image capturing unit and the second image capturing unit are arranged so as to sandwich the projection unit.

7. The apparatus according to claim 6, wherein the first image capturing unit and the second image capturing unit are arranged symmetrically with respect to the projection unit.

8. The apparatus according to claim 1, wherein the processing unit corrects the measurement error by averaging the first three-dimensional measurement values obtained from the first image and the second image corresponding to the overlap region.

9. The apparatus according to claim 1, wherein the processing unit sets, as the overlap region, a region obtained by excluding, from a region captured by both of the first image capturing unit and the second image capturing unit, an edge region of the object and a region where a surface inclination amount of the object is larger than a reference inclination amount.

10. A measurement method of performing three-dimensional measurement of an object, comprising:
obtaining three-dimensional information regarding the object based on a first image and a second image obtained by a first image capturing unit and a second image capturing unit, respectively, by capturing the object with pattern light projected thereon by the first image capturing unit and the second image capturing unit from directions different for each image capturing unit,
wherein in the obtaining, a measurement error of a second three-dimensional measurement value obtained from data of one of the first image and the second image corresponding to a non-overlap region captured by the one of the first image capturing unit and the second image capturing unit is corrected using first three-dimensional measurement values obtained from data of the first image and data of the second image corresponding to an overlap region captured by both of the first image capturing unit and the second image capturing unit.

11. A system comprising:
a measurement apparatus defined in claim 1 that performs three-dimensional measurement of an object; and
a grip apparatus configured to grip the object based on three-dimensional information of the object measured by the measurement apparatus.

12. A non-transitory computer readable storage medium storing a program for causing a computer to execute each step of a measurement method of performing three-dimensional measurement of an object, the method comprising:
obtaining three-dimensional information regarding the object based on a first image and a second image obtained by a first image capturing unit and a second image capturing unit, respectively, by capturing the object with pattern light projected thereon by the first image capturing unit and the second image capturing unit from directions different for each image capturing unit,
wherein in the obtaining, a measurement error of a second three-dimensional measurement value obtained from data of one of the first image and the second image corresponding to a non-overlap region captured by the one of the first image capturing unit and the second image capturing unit is corrected using first three-dimensional measurement values obtained from data of the first image and data of the second image corresponding to an overlap region captured by both of the first image capturing unit and the second image capturing unit.

13. An information processing apparatus that performs three-dimensional measurement of an object, comprising:
a processing unit configured to perform a process of obtaining three-dimensional information regarding the object based on a first image and a second image obtained by a first image capturing unit and a second image capturing unit, respectively, by capturing the object with pattern light projected thereon by the first image capturing unit and the second image capturing unit from directions different for each image capturing unit,
wherein the processing unit corrects, using first three-dimensional measurement values obtained from data of the first image and data of the second image corresponding to an overlap region captured by both of the first image capturing unit and the second image capturing unit, a measurement error of a second three-dimensional measurement value obtained from data of one of the first image and the second image corresponding to a non-overlap region captured by the one of the first image capturing unit and the second image capturing unit.
